(19) United States
(12) Patent Application Publication
(10) Pub. No.: US 2024/0356118 A1
(43) Pub. Date: Oct. 24, 2024

(54) COIN CELL BATTERY

(71) Applicant: Panasonic Intellectual Property Management Co., Ltd., Osaka (JP)

(72) Inventors: YOKO SANO, Osaka (JP); NOBORU NAKA, Nara (JP); HIROYUKI AKIYA, Kyoto (JP)

(21) Appl. No.: 18/684,690

(22) PCT Filed: Jun. 24, 2022
(86) PCT No.: PCT/JP2022/025230

§ 371 Date: Feb. 19, 2024

(30) Foreign Application Priority Data
Sep. 27, 2021 (JP) 2021-156251

(51) Int. Cl. H01M 50/16; H01M 50/109; H01M 50/153; H01M 50/164; H01M 50/548

(52) U.S. Cl. CPC H01M 50/16; H01M 50/109; H01M 50/153; H01M 50/164; H01M 50/548

(57) ABSTRACT

A coin cell battery includes a sealing plate having one polarity and a battery can having another polarity. A mark of a letter, a number, a symbol, a shape, a color, or a combination thereof is formed on an outer surface of at least of the sealing plate and the battery can. The mark is made of a layer containing an aversive agent.

### TECHNICAL FIELD

The present disclosure relates to a coin cell battery preventing accidental ingestion.

### BACKGROUND ART

A technique of applying an aversive agent that has unpleasant flavor, such as bitter and spicy tastes, onto a surface of a coin cell battery has been known as a measure for preventing accidental ingestion of a coin cell battery by infants. When an infant accidentally put a coin cell battery in his/her mouth, the infant spits out the battery in a reflexive manner by an effect of the aversive agent, thereby preventing ingestion of the battery.

The aversive agent is often applied onto a battery surface in order to provide a quick action in the mouth. However, since the aversive agent is often not electrically conductive, the aversive agent may provide a problem reducing conductivity of the battery surface. Therefore, PTL 1 discloses a structure of providing multiple recesses in the battery surface and applying a substance with unpleasant flavor into these recesses. PTL 2 discloses a structure of applying the aversive agent on the surface or inside insulative gasket of the coin cell battery.

On the other hand, a manufacturer, model number, type number, production area, polarity, and so on are normally indicated on the surface of the coin cell battery, using a mark or engraved portion including a letter, a number, a shape, a symbol, or a combination thereof in order to indicate product identification and safety. For example, PTL 3 discloses a monogram indication of letters, numbers, and shapes or a combination thereof printed on the coin cell battery using color paint.

### CITATION LIST

### Patent Literature

PTL 1: Japanese Utility Model No. S59-62666
PTL 2: Japanese Patent No. 6000252
PTL 3: Japanese Patent Laid-Open Publication No. 2001-110370

### SUMMARY OF THE INVENTION

In order to provide multiple recesses in a surface of a battery can in the technique disclosed in PTL 1, a can thickness is reduced at the recesses, hance decreasing a strength of the sealing plate or the battery can of the battery. Still more, in a manufacturing process, steps of forming the recesses and applying a substance with unpleasant flavor need to be added, resulting in decreasing a battery production efficiency.

In the technique disclosed in PTL 2, an aversive agent is applied onto the surface of an insulative gasket of a coin cell battery. Similar to PTL 1, this requires an additional step of applying the aversive agent. In addition, it is extremely difficult to apply the aversive agent only to the gasket of a coin cell battery with small diameter. As a result, the battery production efficiency decreases. Furthermore, when the aversive agent is provided inside the insulative gasket of the battery, an effect of the aversive agent may not be sufficiently performed, resulting in decreasing the effect of preventing accidental ingestion.

In the technique disclosed in PTL 3, when the aversive agent is further applied onto the surface of the coin cell battery after a monogram is indicated using color paint, an effective conductive portion on the battery surface reduces due to the presence of both a color paint portion and an aversive agent portion on the battery surface.

A coin cell battery in an aspect of the present disclosure includes a sealing plate having one polarity and a battery can having another polarity. A mark including a letter, a number, a symbol, a shape, a color, or a combination thereof is formed, using an aversive layer containing an aversive agent on an outer surface of at least one of the sealing plate and the battery can.

A coin cell battery in another aspect of the present disclosure includes a sealing plate having one polarity and a battery can having another polarity. An engraved portion including a letter, a number, a symbol, a shape, a color, or a combination thereof is provided in the outer surface of at least one of the sealing plate and the battery can, and the aversive layer containing the aversive agent is provided on the engraved portion.

In the coin cell battery of the present disclosure, the aversive agent is provided only in a marked portion formed on the battery surface. Therefore, accidental ingestion of the battery is effectively prevented without significantly reducing conductivity while maximizing the effective conductive area on the battery surface.

Furthermore, the mark and application of the aversive agent may be formed simultaneously because the mark is made of the aversive layer containing the aversive agent.

### BRIEF DESCRIPTION OF DRAWINGS

FIG. 1 is a schematic sectional view of a coin cell battery according to an exemplary embodiment of the present disclosure.

FIG. 2 is a plan view of the coin cell battery according to the embodiment.

FIG. 3A is a plan view of another coin cell battery according to the embodiment.

FIG. 3B is a plan view of still another coin cell battery according to the embodiment.

FIG. 3C is a plan view of a further coin cell battery according to the embodiment.

FIG. 3D is a plan view of a further coin cell battery according to the embodiment.

FIG. 3E is a plan view of a further coin cell battery according to the embodiment.

FIG. 3F is a plan view of a further coin cell battery according to the embodiment.

FIG. 4A is a plan view of a further coin cell battery according to the embodiment.

FIG. 4B is a plan view of a further coin cell battery according to the embodiment.

FIG. 4C is a plan view of a further coin cell battery according to the embodiment.

FIG. 4D is a plan view of a further coin cell battery according to the embodiment.

### DESCRIPTION OF EMBODIMENT

A coin cell battery according to an exemplary embodiment of the present disclosure will be described with reference to the drawings. A lithium primary battery is given as an example of the coin cell battery according to the exemplary embodiment. However, the present disclosure is not limited thereto and also applicable to a lithium secondary battery, a dry battery, and other known coin cell batteries. The coin cell battery of the present disclosure includes a button battery and a flat battery.

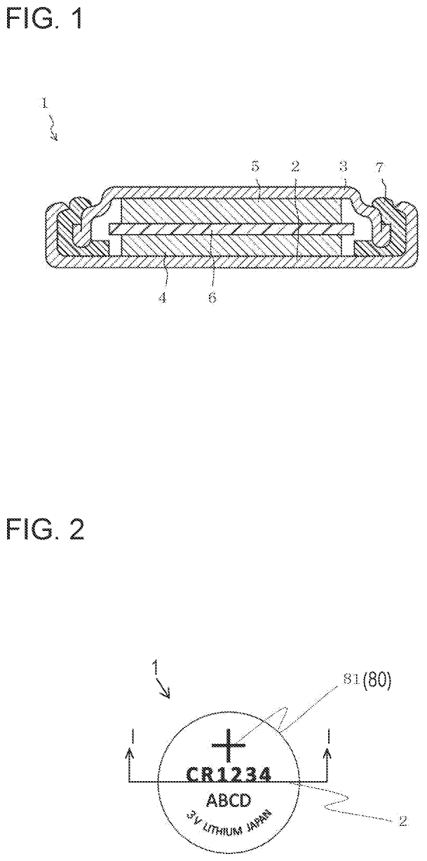

FIG. 1 is a schematic sectional view of coin cell battery 1 according to an exemplary embodiment of the present disclosure. FIG. 2 is a plan view of coin cell battery 1. FIG. 1 illustrates a cross section of coin cell battery 1 along line I-I shown in FIG. 2. As illustrated in FIG. 1, coin cell battery 1 according to the embodiment includes an outer case of battery can 2 having one polarity and sealing plate 3 having another polarity. Each of battery can 2 and sealing plate 3 includes a circular flat part and a cylindrical side wall connected to an outer periphery of the circular flat part, and is made of iron or iron alloy such as stainless steel.

A diameter of the circular flat part of battery can 2 is larger than a diameter of the circular flat part of sealing plate 3. The circular flat parts of battery can 2 and sealing plate 3 face each other such that the cylindrical side wall of sealing plate 3 is disposed inside the cylindrical side wall of battery can 2. A power generating element including positive electrode 4, negative electrode 5, separator 6, and non-aqueous electrolyte is accommodated inside battery can 2 and sealing plate 3. Battery can 2 and sealing plate 3 are sealed with gasket 7.

Positive electrode 4 contains manganese dioxide as an active material and known conductive agent and binder added thereto. As the conductive agent, for example, natural graphite, artificial graphite, carbon black such as Ketjen black and acetylene black, and carbon fiber are used. As the binder, for example, fluororesin such as PTFE and PVDF is used.

Lithium metal and lithium alloy such as lithium-aluminum alloy are used for negative electrode 5. Alternatively, negative electrode 5 may be a multilayer sheet obtained by forming a known layer, such as an aluminum layer and a carbon layer, on a surface of the lithium metal or the lithium alloy.

A porous polypropylene resin sheet is used as separator 6. Alternatively, a porous sheet of a single layer or a multilayer of polyolefin resin and a known separator such as non-woven fabric may be used for separator 6.

For the non-aqueous electrolyte, a known non-aqueous solvent, such as γ-butyrolactone 1,2-dimethoxyethane, propylene carbonate, and ethylene carbonate or a combination thereof, may be used as the non-aqueous solvent. As electrolyte, known lithium salt, such as LiCIO₄, LiBF₄, LiPF₆, LiCF₃SO₃, and LiN (CF₃SO₂)₂ or a combination thereof, may be used.

The positive electrode faces battery can 2 and connected to battery can 2, and the negative electrode faces sealing plate 3 and connected to sealing plate 3. As a result, battery can 2 having a positive polarity and sealing plate 3 having a negative polarity are provided.

As illustrated in FIG. 2, mark 81 (all solid black portions) including a letter, a number, a symbol, a shape, a color, or a combination thereof is formed on a flat outer surface of the circular flat part of battery can 2 having the positive polarity. Mark 81 indicates safety and product identification, such as a battery manufacturer, model, type, production area, and polarity. In the circular flat part, a size, shape, pattern, and so on of the letter, number, and the like can be changed as appropriate. The mark on the flat outer surface of battery can 2 is effective for forming a more readily noticeable large mark because the mark can be formed on a flat surface with a larger diameter. However, the present disclosure is not limited thereto. Mark 81 may be formed on the outer surface of the circular flat part of sealing plate 3 having negative polarity.

Mark 81 is made of aversive layer 80 containing at least one aversive agent.

Here, the aversive agent is not particularly limited as long as a known aversive agent is used. The aversive agent includes all chemical substances that make infants and adults feel strange, unpleasant or nausea when the substance is put in a mouth. The aversive agent may be formed of a single substance or a mixture of two or more substances. Examples of the aversive agent are denatonium salt such as denatonium benzoate, denatonium saccharide, and denatonium chloride; pyrethrum extract, amur cork extract, Agaricus blazei extract, lychee extract, Coriolus versicolor extract, naringin, humulone compound, catechin, caffeine, anthocyanin, amino acids, cucurbitacin, phenylthiocarbamide, calcium, magnesium sulfate, magnesium chloride, catechins, alkaloids, alkaloids, xanthins, terpenes, triterpenoids, and terpene glucoside.

As the aversive agent, pungent-taste compounds such as capsaicin, isothiocyanic ester, and sinigrin, or sour-taste compounds such as citrate, tartanic acid, fumaric acid, sodium fumarate, malic acid, and adipic acid may be used. So-called emetic, a compound that induces vomiting such as ipecaucuanha, may also be used.

Mark 81 is formed on the battery surface with an inkjet system, an ink transfer system, a hot stamp system, and the like, with ink normally used for printing with which above-described aversive agent is mixed. A mixing ratio of the ink and the aversive agent may be set in a range as appropriate that does not deteriorate a fast-acting effect of the aversive agent and productivity.

Aversive layer 80 is applicable to a range of metal sheets used for the coin cell battery, such as a steel sheet and a stainless steel sheet. In ink-marking methods, the inkjet system is particularly preferable because the inkjet system has high adaptability to small and large coin cell batteries. Aversive layer 80 contains the aversive agent, a binder, and a solvent.

As the binder of aversive layer 80, known organic and inorganic materials can be used. Examples of the organic material are cellulose-based resin such as carboxymethyl cellulose, methyl cellulose, ethyl cellulose, and crystalline cellulose; ester resin, olefin resin, acrylic resin, epoxy resin, urethane resin, alkyd resin, vinyl chloride resin, melamine resin, and phenolic resin. Examples of the inorganic material are known materials such as silicon-based and ceramic-based materials. Still more, the inorganic material includes water-soluble resin such as polyvinyl alcohol resin and polyvinylpyrrolidone. Water-soluble starch and carboxylmethyl cellulose may also be used.

As the solvent of aversive layer 80, for example, one or a combination of glycerin, ethylene glycol, propylene glycol, and ethanol may be used as a water-soluble organic solvent. In addition, aliphatic alcohols, their esters, and a combination thereof may be used.

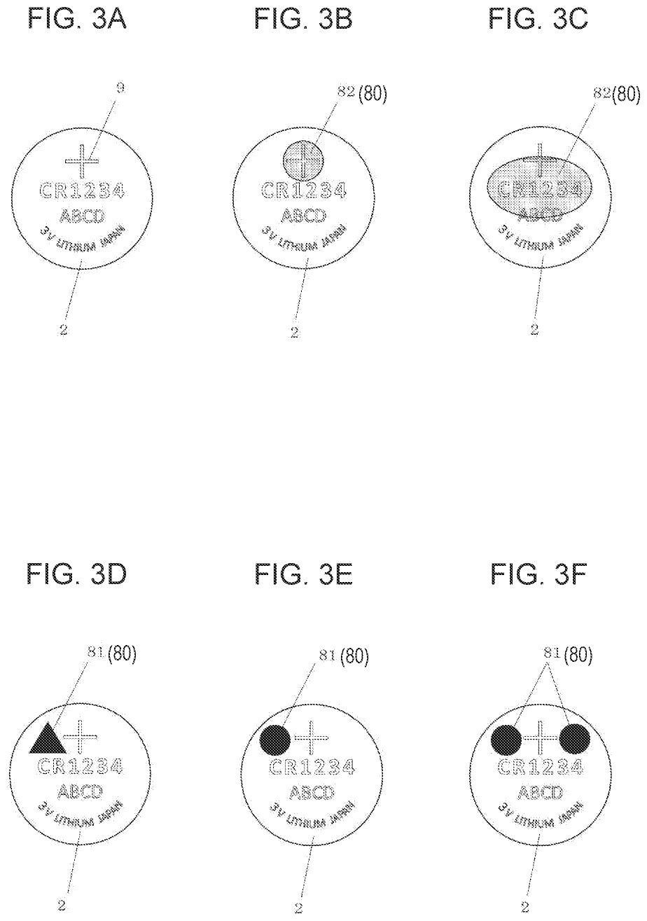

FIGS. 3A-3F are plan views of other coin cell batteries 1 according to the embodiment. In addition to formation of the mark directly on the circular flat part of the battery can, as illustrated in FIG. 2, engraved portion 9 with the same shape as the mark is formed on the outer surface of the flat part of the battery can, as illustrated in FIG. 3A, and then aversive layer 80 may be formed in engraved portion 9. Engraved portion 9 is formed of a groove engraved in the outer surface of the battery can, and is preferably formed by press with a marking die. Alternatively, engraved portion 9 may be formed by laser irradiation.

In a coin cell battery illustrated in FIG. 3B, mark 82 is made of aversive layer 80 covering engraved portion 9. In a coin cell battery illustrated in FIG. 3DC, mark 82 is made of aversive layer 80 covering engraved portion 9 indicating the polarity, model, and manufacturer.

Mark 82 illustrated in FIGS. 3B and 3C may be made of the same material and forming system as aforementioned mark 81.

In addition, aversive layer 80 may protrude from engraved portion 9, or may partially cover engraved portion 9. In a coin cell battery illustrated in FIG. 3D, mark 81 is made of aversive layer 80 of ink containing the aversive agent on a portion the surface other than engraved portion 9. In a coin cell battery illustrated in FIG. 3E, mark 81 is made of aversive layer 80 on a portion of the surface other than engraved portion 9 of the battery. In a coin cell battery illustrated in FIG. 3F, marks 81 are made of the aversive layer on a portion of the surface other than engraved portion 9 of the battery. As illustrated in FIGS. 3D-3F, mark 81 with various shapes and designs may be made of aversive layer 80 made of ink containing the aversive agent on the circular flat part other than engraved portion 9.

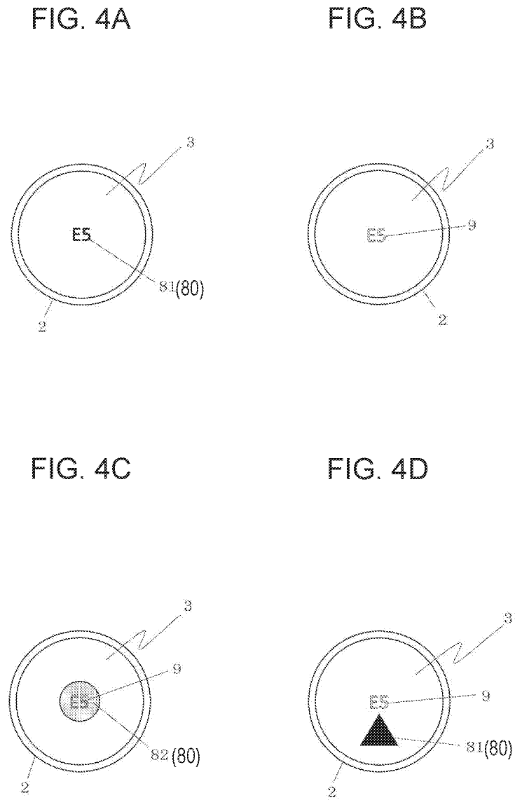

FIGS. 4A-4D are plan views of still another coin cell batteries 1 according to the embodiment. FIG. 2 and FIGS. 3A-3F illustrate examples in which mark 81 or 82 is formed on the outer surface of the flat part of battery can 2 having the positive polarity. As illustrated in FIGS. 4A-4D, similar effects can be achieved by forming mark 81 or 82 on the outer surface of the flat part of sealing plate 3 having the negative polarity. As illustrated in FIGS. 4A-4D, marks 81 and 82 and engraved portion 9 may be formed similarly to aversive layer 80 formed on battery can 2 shown in FIGS. 2-3F. In a coin cell battery illustrated in FIG. 4A, mark 81 is made of aversive layer 80 on the outer surface of the flat part of sealing plate 3 having the negative polarity. In a coin cell battery illustrated in FIG. 4B, engraved portion 9 is formed in the outer surface of the flat part of sealing plate 3 having the negative polarity. In a coin cell battery illustrated in FIG. 4C, mark 82 is made of aversive layer 80 containing the aversive agent, and aversive layer 80 covers engraved portion 9. In a coin cell battery illustrated in FIG. 4D, mark 81 is made of aversive layer 80 on a portion of the surface other than the engraved portion.

FIGS. 1-4F illustrate examples of marks 81 and 82 formed with the inkjet system using black ink. However, ink colors other than black may be adopted with the purpose of giving impact.

The aversive agent contained in aversive layer 80 forming marks 81 and 82 preferably includes at least denatonium benzoate because denatonium benzoate is a general bittering agent that is easily available.

Aversive layer 80 is preferably electrically conductive. Electrical conductivity of aversive layer 80 provides marks 81 and 82 that are normally not conductive with conductivity. This configuration increases electrical conductivity of the entire flat part of the battery where mark 81 or 82 is formed. An electrically-conductive material is not particularly limited as long as it is a known material. For example, conductive carbon materials, such as graphite and carbon black and metal fine powder of gold, silver, copper, nickel, aluminum, molybdenum, tungsten, tantalum, tin, indium, titanium, yttrium, zinc, magnesium, cerium, strontium, lead, platinum, palladium, or a combination thereof may be preferably used.

Aversive layer 80 is preferably colored, or configured to generate color or emit light upon having light applied thereto. Colored aversive layer 80 or aversive layer 80 configured to generate color or emit light upon having light applied thereto is effective for confirming that aversive layer 80 is reliably formed on the battery surface. In particular, when the battery is stored for a long period, it is determined whether or not the effect of the aversive agent remains can be effectively determined by observing a level of color generation or light emission at applying light.

Examples of a material of aversive layer 80 configured to generate color or emit light upon having light applied thereto are a material including barium or strontium that is fluorescent paint, and fluorescein. A known material configured to emit light upon having ultraviolet ray with wavelength ranging from 380 nm to 480 nm is applied may be used.

As pigment for coloring aversive layer 80, organic pigment, such as lake red, eosin-based lake, phthalocyanine green, green gold, phthalocyanine blue, and methyl violet lake, may be used. Lake red and eosin-based lake may color in red color. Phthalocyanine green may color in green color. Green gold may color in yellowish green color. Phthalocyanine blue may color in blue color. Methyl violet lake may color in purple color.

Aversive layer 80 may be formed in dots or colored. By combining various colors and dots, diversifying mark designs and patterns can be created. In the case that the inkjet system is adopted for forming aversive layer 80, various marks may be efficiently created. The size and position of the mark to be formed are set as appropriate within a range not significantly deteriorating the conductivity.

In coin cell battery 1 of the present disclosure, the aversive agent does not exist in an area other than marks 81 and 82 formed on the battery surface. Therefore, there is no significant decrease in the conductivity. As a result, accidental ingestion of the battery is effectively prevented without significantly decreasing the conductivity while maximizing the effective conductive area on the battery surface.

Since marks 81 and 82 are made of aversive layer 80 containing the aversive agent, the formation of the mark and the application of the aversive agent are performed simultaneously. As a result, the aversive agent is efficiently applied to the battery surface without adding a new process to the battery manufacturing process.

As described above, when the aversive agent is applied to the surface of coin cell battery 1, coin cell battery 1 having effective accidental ingestion prevention and good conductivity is achieved without significantly reducing the effective conductive portion on the battery surface due to application of the aversive agent and without adding another process for applying the aversive agent.

The coin cell battery according to the embodiment refers to the lithium primary battery using manganese dioxide for the positive active material and lithium metal for the negative active material. However, the present disclosure is not limited thereto. The present disclosure is applicable to known coin type batteries including lithium-ion batteries, lithium secondary batteries, manganese dry batteries, and alkaline dry batteries.

### INDUSTRIAL APPLICABILITY

A coin cell battery of the present disclosure prevents accidental ingestion of the battery, and is reliably applicable to various equipment including the coin cell battery as a power source.

### REFERENCE MARKS IN THE DRAWINGS

1 coin cell battery
2 battery can
3 sealing plate
4 positive electrode
5 negative electrode
6 separator
7 gasket
80 aversive layer
81, 82 mark
9 engraved portion

1. A coin cell battery comprising:
a sealing plate having one polarity;
a battery can having another polarity; and
an aversive layer provided on an outer surface of at least one of the sealing plate and the battery can, the aversive layer containing an aversive agent, wherein
a mark made of the adverse layer is provided on the outer surface of the at least one of the sealing plate and the battery can, the mark comprising a letter, a number, a symbol, a shape, a color, or a combination thereof.

2. A coin cell battery comprising:
a sealing plate having one polarity;
a battery can having another polarity; and
an aversive layer provided on an outer surface of at least one of the sealing plate and the battery can, the aversive layer containing an aversive agent, wherein
an engraved portion is formed in an outer surface of at least the sealing plate and the battery can, the engraved portion being a letter, a number, a symbol, a shape, or a combination thereof, and
a mark made of the adverse layer is provided at the engraved portion.

3. The coin cell battery of claim 1, wherein the aversive agent contains denatonium benzoate.

4. The coin cell battery of claim 1, wherein the aversive layer is electrically conductive.

5. The coin cell battery of claim 1, wherein the aversive layer is colored, or is configured to generate color or emit light upon having light applied thereto.

6. The coin cell battery of claim 1, wherein the aversive layer is formed in a dot pattern.

7. The coin cell battery of claim 1, wherein the mark is formed on an outer surface of the sealing plate.

8. The coin cell battery of claim 2, wherein the aversive agent contains denatonium benzoate.

9. The coin cell battery of claim 2, wherein the aversive layer is electrically conductive.

10. The coin cell battery of claim 2, wherein the aversive layer is colored, or is configured to generate color or emit light upon having light applied thereto.

11. The coin cell battery of claim 2, wherein the aversive layer is formed in a dot pattern.

12. The coin cell battery of claim 2, wherein the mark is formed on an outer surface of the sealing plate.
